(19) United States
(12) Patent Application Publication
(10) Pub. No.: US 2009/0221360 A1
(43) Pub. Date: Sep. 3, 2009

(54) Electronic Gaming Network

(76) Inventor: Steven Wooding, Buckinghamshire (GB)

Correspondence Address: William J. McNichol, Jr. Esq.;Reed Smith LLP, 2500 One Liberty Place, 1650 Market Street, Philadelphia, PA, 19103, US

(21) Appl. No.: 12/224,584

(22) PCT Filed: Mar. 1, 2007
(86) PCT No.: PCT/GB2007/000727

§ 371 Date: May 15, 2009

(30) Foreign Application Priority Data
Mar. 3, 2006 (GB) 0604322.8

(51) Int. Cl. A63F 13/12

(52) U.S. Cl. 463/25; 463/42

(57) ABSTRACT

An electronic gaming network (1) having a server (2) and a plurality of remote gaming terminals (6). Each terminal (6) includes a credit receiver (14) and a payment generator (16). On the basis of play requests received in the server, the network is arranged to interlink two or more of the remote terminals to enable users of those terminals to engage in game play with one another. On the basis of gamble stakes received in the server and accepted by the users, the network is arranged to calculate a win value, and cause a winnings amount to be delivered to the user who wins the game play via the payment generator on that user's terminal.

### FIELD OF THE INVENTION

The invention relates to networked gaming systems. It relates to systems which allow two or more users located remotely from one another to participate in the same game. The invention can be applied to networked game terminals located in venues such as pubs or betting offices.

### BACKGROUND TO THE INVENTION

Head-to-head gaming is a well known concept, involving two or more players engaging in competition, e.g. a game of skill and/or chance, to determine a winner. It is known to network individual gaming machines e.g. in an amusement arcade to enable users to play against one another.

The advent of the Internet has created a new forum for head-to-head gaming, where gamers can be located remotely from one another. The introduction of fast communication speeds, e.g. using broadband technology, makes remote gaming in this way even more feasible. Thus, Internet sites exist where remote users may log on and engage in head-to-head competition in games such as battleships, pool, blackjack, golf etc. The website gameaccount.com is an example of such a website. Here, users may register with the site in order to compete against each other for monetary prizes.

In order for Internet interactive gaming sites to operate safely and securely, it is necessary for each user to register personal details, e.g. bank details, so that they can demonstrate that they are able to pay for participation and in order to receive their winnings. From the games industry point of view, the requirement to enter personal details is undesirable, because it can act as a deterrent to potential gamers, e.g. because they are unwilling to spend the time entering their details, or they resent the intrusion into their privacy. However, such security is necessary for remote head-to-head Internet gaming for prizes to function.

### SUMMARY OF THE INVENTION

Expressed generally, the invention provides a network of gaming terminals that are arranged to permit head-to-head gaming between remote users in which physical monetary (e.g. cash) prizes can be directly delivered by the terminals based on the outcome of game play.

Gaming terminals with the ability to physically deliver monetary prizes are known. However, such prizes were dependent on the interaction between the user and the terminal. In the invention, the prizes awarded may be dependent on an interaction with another user on a remote terminal.

Accordingly, the invention may provide a plurality of remote networked gaming terminals which are arranged to provide head-to-head gaming and to facilitate betting on the outcome of that gaming, wherein each terminal is arranged to physically receive a user's credit and to physically dispense a user's winnings. Because each terminal is arranged to receive and dispense funds, there may be no need for the user to register personal details e.g. bank account information or the like. Head-to-head game play may therefore be more quickly accessible.

In one aspect, there may be provided an electronic gaming network for allowing two or more remote users to engage in game play, the network having: a server and two or more remote user terminals which are communicable with one another via the server, each terminal including: credit receiving means arranged to receive monetary input, each terminal being arranged to allocate credit to the user of that terminal based on the value of their monetary input; a display for showing game play; user operable game control means for controlling game play; and payment awarding means arranged to deliver a physical payment to a user; wherein the network is arranged: to receive play requests in the server from the two or more user terminals; to receive gamble stakes in the server from the two or more user terminals, each gamble stake comprising all or part of the credit allocated to a user on a respective user terminal; based on the received play requests, to interlink two or more user terminals to enable the users of the interlinked user terminals to engage in game play with one another; to calculate a win value on the basis of the received gamble stakes; and after game play concludes, to cause a winnings amount to be delivered by the payment awarding means of the terminal of the user who wins the game play, the winnings amount being based on the calculated win value. Such a network provides remote head-to-head game play with the facility to bet on the outcome, without a requirement to enter personal details whilst still maintaining a financially safe and secure environment. The game play provided by the network may be of any suitable head-to-head competition type. For example, the game may be skill based, e.g. pool or golf, but may include or consist of elements of chance e.g. poker, blackjack, etc.

In one embodiment, the head-to-head game play is between two remote users only, although it is possible for a plurality of users to compete in the same game, e.g. in a “winner takes all” set up.

The game play may comprise a series of alternate moves made by the users, e.g. chess, backgammon, battleships, etc. Given fast enough data transmission between the terminals, real time games where the users make simultaneous commands, e.g. driving or flying simulators or “beat 'em ups”, are also possible.

The remote user terminals may be located in separate venues spread over a wide geographical (global) area. In one embodiment, the remote user terminals are communicable over a wide area network (WAN). A plurality of remote user terminals may be provided in a single venue, e.g. interlinked over a local area network (LAN). Each venue linked to the network preferably has a hub or router to which its terminals are connected. The routers may then be connected to a remote central server, e.g. via a broadband connection.

The credit receiving means may be arranged to receive a variety of monetary inputs. For example, it may include one or more of a coin slot, credit card receptacle, paper currency reader, token receptacle and barcode reader. The monetary input may be direct, e.g. cash, i.e. coins or notes. Alternatively, the monetary input may be indirect, e.g. via credit card, bar-coded ticket, tokens, etc. The credit awarded by the terminal may be directly representative of the money, e.g. the monetary value itself, or the credit may be in units corresponding to a predetermined monetary amount. In this case, the payment awarding means may be arranged to convert the unused credit into a monetary value.

The display may be a video screen. The user operable game control means may include any of well known peripheral devices, e.g. mouse, joystick, steering wheel, keyboard, etc. In one embodiment, the display and user operable game control means are combined in a touch screen arrangement. Of course, auxiliary control means may be used in addition to a touch screen.

The payment awarding means may be arranged to deliver winnings to a user by token, printed cheque, bar-coded ticket, etc. The payment awarding means may be arranged to deliver all or part of the winnings amount and/or to deliver unused credit. Delivering payment in this way can avoid the problem of the value of winnings or unused credits being greater than the amount of cash contained in the terminal. Nevertheless, the payment awarding means may also be arranged to deliver payment directly, e.g. in the form of cash, e.g. for unused credit and/or winnings below a predetermined value. The credit receiving means and payment awarding means may comprise a “ticket-in, ticket-out” (TITO) system to permit a cashless gaming. A ticket produced by the payment awarding means may be exchanged for cash elsewhere e.g. at a nearby booth or at the bar in a pub. Another possibility is that the payment awarding means is arranged to cause a cheque to be delivered through the post (via mail) to the user. Of course, in this arrangement, the user would need to input his address details in order for the payment to be delivered. However, this step can be carried out after the game has completed, in contrast to the pre-game registration requirements of the prior art.

The play request may be a simple notification from the terminal to the server, indicating that there is a user ready to play on that terminal. The play request may identify the terminal sending the request and the game that the user wishes to play. The terminal may be arranged to deduct an entry fee from a user's credit once a pay request is sent to the server. The entry fee is preferably separate from the gamble stake. The terminal may include separate inputs and/or receptacles for the entry fee and gamble stake respectively.

Before game play can start, it is necessary to link up two (or more) users who wish to play the same game for an agreed prize. This can be done in a number of ways. The user may be able to select an opponent from other users who wish to participate in the same game. The server may be arranged to communicate a “lobby” screen to each terminal showing the available opponents for a given game upon receipt of a play request. The opponents may be identified by name, location (venue) or other suitable characteristic. After the user has selected an opponent (and the opponent has agreed to be selected), the users must agree on a gamble stake. The network may facilitate a negotiation process where each user proposes a stake in turn and the other user may either accept or reject it. Thus, the server may be arranged to interlink two or more user terminals before the gamble stakes are received in the server to permit a gamble stake negotiation between the interlinked user terminals, whereby each interlinked terminal is arranged to: permit a user to select a proposed gamble stake; send the proposed gamble stake to each of the other interlinked terminals; receive and display an offered gamble stake from each of the other interlinked terminals; permit a user to accept or reject the offered gamble stake; and receive an indication from each of the other interlinked terminals whether the proposed gamble stake is accepted or rejected; and wherein the network is arranged to permit game play to commence between two or more of the interlinked terminals each of which has indicated acceptance of the proposed gamble stake of the others.

Alternatively, there may be one or more predetermined stakes associated with each game such that a user selects a stake at the same time as requesting to play a game. In this case, the opponents in the “lobby” screen will have already indicated that they too wish to play that game at that stake. Further, the “lobby” screen may be omitted. Instead, the server may simply match (e.g. at random) users who are requesting to play the same game at the same stake.

In one embodiment, the network includes software arranged to provide secure communications over the wide area network between the terminals via the server so that the transactions and negotiations are secure from outside interference.

The win award may be based on a sum of the gamble stakes. The win award may be made exactly equal to the sum of the stakes, but preferably a small amount is taken off e.g. as commission.

As mentioned above, there may be only one winner of each game play. The user that wins may receive the winnings amount. They may be able to extract this from the payment awarding means. Alternatively, it may be converted to or automatically appear as an increase in the credit on their terminal. The user then may use this credit to fund further games. The user or users that participate in game play and do not win have their credit values decreased by their gamble stake (in addition to any entry fee payable on sending the play request). Typically, a user's credit will be decreased as soon as game play commences (i.e. before the result of the game is determined).

In one embodiment, a user cannot place a gamble stake that is larger than the credit available to him on his terminal. However, the network may be arranged to generate a payment prompt for a user if the user attempts to play a game or place a stake which is beyond his credit fund.

One result of the payment system described above is that terminals which are played by successful users will “payout” more funds than terminals used by less successful users. In known networked terminals, the venue is usually rewarded for hosting the terminal by taking a proportion of the amount of money held by the machine. However, in the invention, the machine may be configured to payout money to a winning user, so there is no longer necessarily a correlation between the amount of money held by the terminal and the amount of usage it has undergone. Thus, in a subsidiary aspect of the present invention, the gaming network is arranged to keep tally of the amounts lost and won on each terminal for subsequent financial reconciliation between the terminals and their respective hosting venues. Thus, for each game, the interlinked terminals may be arranged to inform the server of the venue to which the terminal belongs or any other means of identifying the terminal itself, the gamble stake involved, the identity or location of the terminal(s) of the opponent in the game, and whether the user of that terminal is the winner or loser. Based on this information, the server may be able to calculate the input or staked funds provided to each terminal and the funds paid out by each terminal, in order to work out the overall value of that terminal. The amounts collected by the terminals can be collected together and redistributed according to predetermined criteria, e.g. in proportion with the amount of money input to each machine.

Another aspect of the invention may be a computer terminal adapted to receive monetary input and to deliver physical payment, the terminal being communicable with remote terminals and being arranged to: enable a user to engage in game play with another user on a remote terminal; facilitate betting on the outcome of that game play with the other user; and deliver a physical winnings payment based on the outcome of that game play.

Other aspects of the invention may be understood from the detailed description below.

### BRIEF DESCRIPTION OF THE DRAWINGS

Examples of the present invention are now described with reference with to the accompanying drawings, in which:

FIG. 1 shows a schematic drawing of a gaming network which is an embodiment of the invention;

FIG. 2 shows a schematic menu screen for display on a terminal;

FIG. 3 shows a schematic stake selection screen for display on a terminal;

FIG. 4 shows a schematic opponent selection screen for display on a terminal;

FIG. 5 shows another example of a stake selection screen for display on a terminal;

FIG. 6 shows a pair of game play data tables which are communicated from a pair of terminals to the server; and

FIG. 7 shows a schematic reconciliation table.

### DETAILED DESCRIPTION; FURTHER OPTIONS AND PREFERENCES

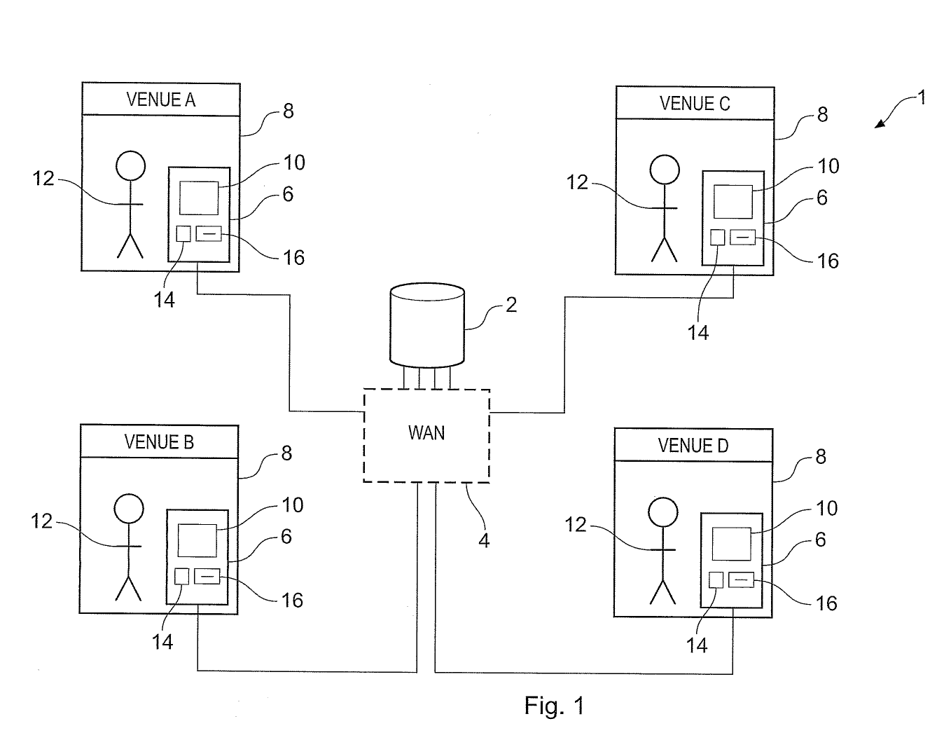

FIG. 1 illustrates a gaming network 1 which is an embodiment of the present invention. The gaming network 1 includes a central server 2 in communication via a wide area network 4 with a number of terminals 6 located in separate (remote) venues 8. These connections can be of the conventional broadband type. Each venue 8 may include a plurality of terminals 6, e.g. interconnected over a local area network; for simplicity, the network 1 shown in FIG. 1 shows one terminal 6 in each venue 8.

Each terminal 6 is of the conventional touch-screen type. Each terminal 6 has a display touch-screen 10, which is arranged to display a game or (more preferably) a selection of games to the user 12, and to display touch-screen options for controlling game play and/or navigating through menus to select which game to play, how much to bet, etc. As an alternative or in addition to the touch-screen 10, auxiliary controls, e.g. joystick, push buttons, keyboard, steering wheel and the like (not shown) may be provided on the terminal 6.

Each terminal 6 includes a credit receiver 14, e.g. coin slot and/or credit card receptacle by which a user 12 can input credit for playing on the terminal 6. For convenience, each terminal has a plurality of credit receivers for receiving different types of credit. Each terminal also includes a payment generator 16 arranged to generate and/or dispense money and/or a coupon or other suitable payment means to the user 12 corresponding to unused credit on the terminal. Thus, if a user 12 is successful in game play, he may recoup his winnings via the payment generator 16. The payment generator 16 can be adapted to provide a plurality of different payment types, e.g. cash, coupon, bar-coded ticket, etc.

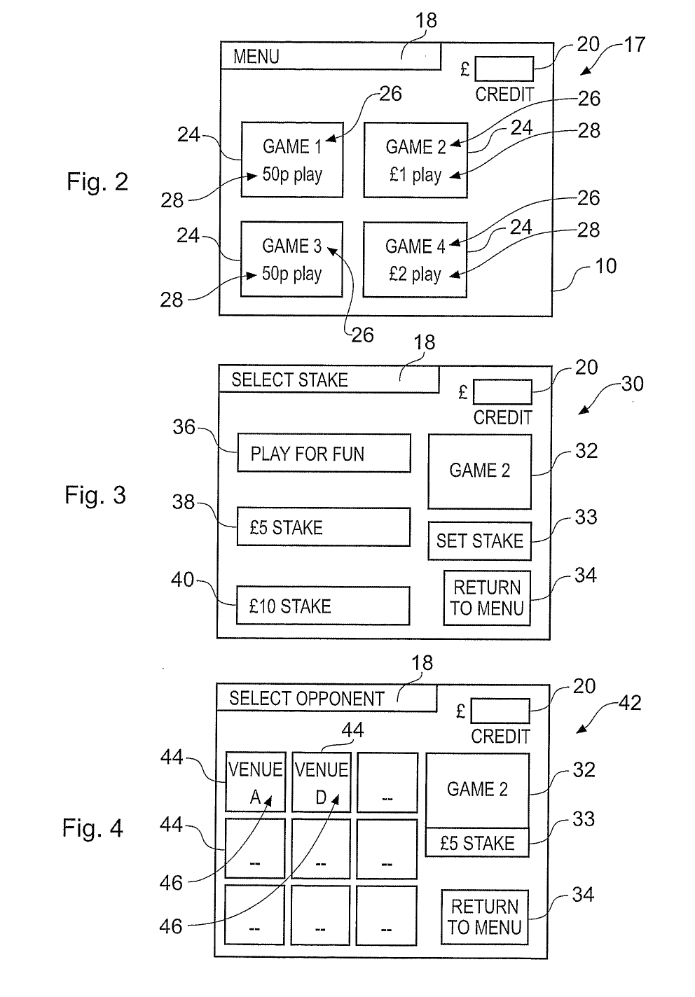

The network 1 depicted in FIG. 1 permits users 12 in remote venues 8 to engage in head-to-head game play over the wide area network 4. The network 1 is provided with software arranged to enable users who wish to play the same game to have their terminals in communication with one another. The network of the present invention also facilitates betting between the users 12 on the outcome of their head-to-head game play. Thus, the network 1 is provided with software arranged to facilitate a bet agreement process before game play commences. In this way, a user may gamble some or all of his credit on the outcome of the game. If he wins, his credit will be increased according to a win award calculated on the basis of the gambled stakes. FIGS. 2 to 5 show examples of options available to the user before game play commences.

FIG. 2 is a schematic representations of a menu screen depicted on the display touch-screen 10 of a terminal 6. The menu screen includes a banner 18 for identifying the screen and a credit display box 20 which is arranged to display the user's available credit. The menu screen 17 includes four touch panels 24, each touch panel 24 offering a different game to the user. Thus, the user may choose to play GAME 2 by selecting the touch panel 24 labelled GAME 2. In this embodiment, each touch panel 24 displays a title 26 of the game together with an entry fee value 28. The entry fee value is deducted from the user's credit when game play commences. In this embodiment, the entry fee 28 is separate from the gamble stake.

After the user has selected the touch panel 24 corresponding to the game he wishes to play, the stake selection screen 30 (see FIG. 3) is displayed on the terminal's screen 10. The stake selection screen 30 includes a selected options display area 32, which shows the game selected by the user in the previous step, and a back navigation touch panel 34 to enable the user to return to the menu screen 17. In this embodiment, the stake selection screen 30 displays a number of touch panels 36,38,40 corresponding to predetermined stake values. In the example shown, touch panel 36 corresponds to a zero value stake, whereby the player may simply play for fun. The network may permit remote users to compete against one another for a zero stake but preferably the network is arranged so that the user plays alone or competes against a computer (e.g. in the terminal 6 itself) when he selects the zero value stake touch panel 36. Touch panel 38 enables the user to select a stake of medium value (e.g. £5 or $5), and touch panel 40 enables the user to select a higher stake (e.g. £10 or $10). The terminal 6 is arranged only to permit the user to select a stake value which is less than or equal to the value represented in his credit box 20. Alternatively or additionally, the terminal 6 may be arranged to display a payment prompt screen (not shown) when a user attempts to select a game or play option for which he does not have enough credit. The payment prompt screen may inform the user how much more credit is required for him to pursue the selected game or play option. Such prompt screens are conventional.

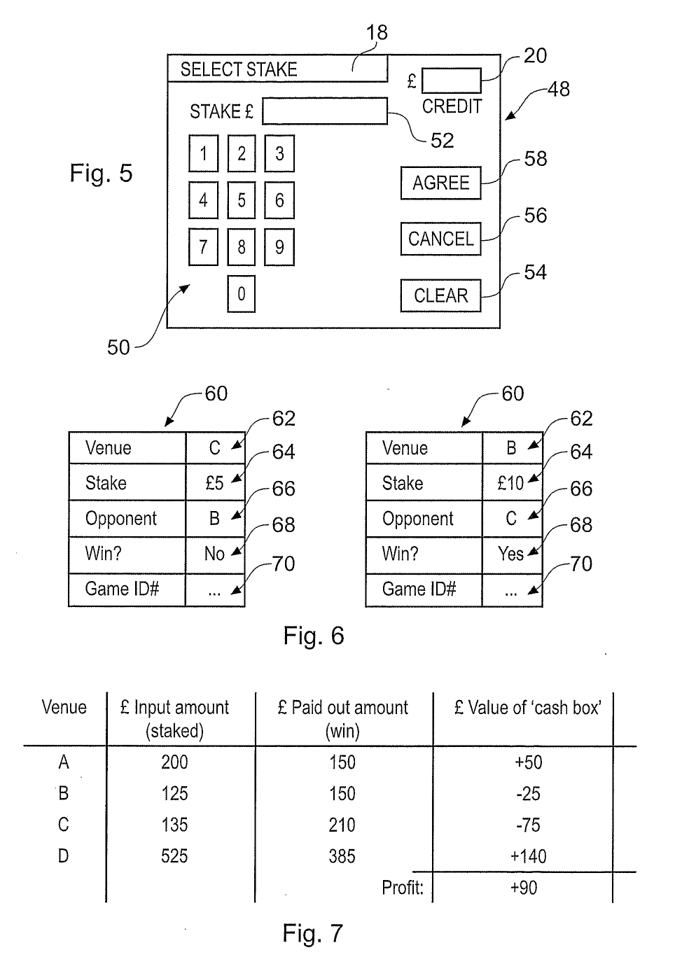

FIG. 3 also shows a set stake panel 33, which takes the user to a further screen where the user has the flexibility to set a stake e.g. with his opponent. FIG. 5 shows an example of such a screen and is described below.

After a stake is selected in stake selection screen 30, opponent selection screen 42 is displayed on the terminal's display screen 10. Similarly to the stake selection screen 30, the opponent selection screen 42 contains a previously selected options display panel 32,33, which, in this example, shows that the user has selected GAME 2 to be played for a £5 stake. In common with the stake selection screen 30, the opponent selection screen also includes the back navigation touch panel 34, the credit box 20 and a banner 18 identifying the screen. The opponent selection screen 42 also includes a plurality of touch panels 44 that are representative of other users who wish to play the same game for the same (or different) stake. A user may therefore select his opponent by choosing one of the touch panels 44. Each touch panel 44 shows an opponent identifier 46, which in this example is the identity of the venue 8 where the opponent's terminal 6 is located. The opponent identifier 46 may also include the stake bet by the opponent. In a preferred example, the user may only select opponents who have bid the same stake. Once the user has selected his stake, he will appear on the opponent's selection screen of other users. Thus, rather than selecting an opponent, the user may wish to wait until he is selected. When a user is selected, the network is arranged to display an accept/reject message on his terminal's screen so that he can choose whether or not to engage the user who has selected him in game play for the selected stake. After two opponents have agreed to play one another for an agreed stake, game play commences.

The opponent selection screen 42 may be omitted. Instead, the server 2 may be arranged automatically to match two users who select the same game e.g. for the same stake. Thus, the user may move straight from the stake selection screen 30 to a screen asking him to accept or reject a given opponent. For games with a set stake, this latter step may also be omitted, so game play commences immediately after the server 2 finds a match between users 12.

Alternatively, the opponent selection screen 42 may be displayed before the stake selection screen 30. In this way, a user can select his opponent before setting his stake.

FIG. 5 shows an alternative stake selection screen 48. Here, the user can manually input a stake value using a touch panel number pad 50. The stake entered by the user on the number pad 50 is displayed in the stake display box 52; a CLEAR touch panel 54 is provided so that the user can delete mistakes in the stake display box 52. A CANCEL touch panel 56 is provided to enable the user to exit this stake selection screen 48. Finally, an AGREE touch panel 58 is provided to enable the user to communicate his chosen stake from the terminal 6 over the network 1. As mentioned above, a user's stake maybe displayed as a part of the opponent identifier 46 in the opponent selection screen 42.

After two users agree that they wish to engage in head-to-head game play with one another for a chosen stake, the server 2 interlinks the terminals 6 to enable game play to take place. The technology enabling this is conventional.

As mentioned above, at the conclusion of game play one user will be the winner, so the credit shown in his credit box 20 needs to be increased by a value corresponding to a win award. The win award is calculated by the server from the gambled stakes agreed by the competing users. It may simply be the sum of the gambled stakes. Alternatively, a commission may be taken, so that the win award corresponds to e.g. 90% of the sum of the gambled stakes. Similarly, the losing user must have their gamble stake deducted from their credit box 20.

One desirable feature of the present invention is to keep track of the bets placed and the movement of gambled stakes to facilitate subsequent financial reconciliation. As explained above, each terminal 6 is equipped with payment awarding device or devices 16 which are arranged to pay out to the user the value of any unused (or won) credit. Whilst the payout may be in cash from funds input to the terminal 6, it is desirable that the payment awarding device 16 delivers a voucher which is redeemable by the user elsewhere in the venue 8, e.g. at the bar in a pub or the cash desk in a betting office. This prevents the situation where a terminal is unable to pay a user because it does not have enough funds. However, in this situation, venues whose terminals are used by successful (winning) users, will be required to payout more money than venues whose terminals are used by people that lose. Clearly, the venues need to recoup the money they pay out, and it may also be desirable to reward them for having successful users. In addition, for machines that accept electronic monetary input, the cash content of the machine is not necessarily an accurate representation of the amount of usage the machine has had. Generally speaking, terminals are valuable to venues only if their usage generates enough revenue. The network of the present invention may therefore be arranged to monitor the usage of all the interconnected terminals and keep a tally of the financial transactions in order for the venues to be properly rewarded for the usage of their machines.

To achieve this, a central record of all the executed games with gambles may be stored in the central server 2 (or a separate server dedicated to reconciliation). Upon the completion of each game, the terminals involved in that game are arranged to send a game play data (transaction report) table to the server 2. A pair of such data tables are shown in FIG. 6. Each table 60 includes venue identifying data 62, which indicates the venue 8 to which the terminal 6 sending the report 60 belongs. The report 60 also includes data 64 representing the value of the stake gambled on the terminal 6 sending the report 60, data 66 identifying the venue to which the opponent's terminal belongs, data 68 indicating whether or not the user of the terminal sending the report 60 won or lost, and, to enable a pair of reports to be matched in the central server, data 70 representing an unique game identifier. Upon receipt of this information, the central server can reconstruct the financial transaction and calculate a “virtual” cash box for each terminal. This virtual cash box can then be compared with the amount of cash actually contained in the terminal and the amount of money redeemed in the venue by users in order to calculate what payments or deductions are required to or from the venue. Where a commission is taken, there should be a profit from the sum total of all cash boxes.

FIG. 7 shows a simplified financial transaction table constructed by the server from game data tables 60. The table indicates the staked amounts made in each venue and, by knowing which terminal was competing with which terminal and which the winning terminal was, the amount paid out by that terminal. The value of the virtual cash box may be simply arrived at by subtracting the paid out amount from the input amount. This table can be used to reconcile payments between all venues.

The reconciliation system may be achieved by implementing a messaging system over the network. For example, Message Oriented Middleware (MOM) may be provided with a server (e.g. data centre) that is arranged to collect and collate financial information from a plurality of client terminals (end points, e.g. gaming terminals) in a variety of venues. In the MOM model, the end points can be considered as publishers which communicate with a subscriber (the data centre) through the MOM. In this case, the publisher sends messages to the MOM, which is arranged to deliver them to appropriate subscribers. Each of the messages has a tag which may identify its content. A subscriber can be adapted to receive messages with particular types of tag. In this way, the publisher can send messages to the MOM with no knowledge of which applications will subscribe to those messages. Moreover, a subscriber can subscribe to all messages on a certain topic without needing to know the location of all of the possible publishers. This system therefore exhibits good scalability.

An advantage of the tagged messaging system is that the type of information delivered to the subscribers can be tightly controlled. For example, a terminal may run a variety of games, which may have different proprietors. The behaviour of the overall terminal cashbox will depend on game play on all of the games that the terminal provides, and game proprietors may be unwilling to allow information which hints at their game's performance to be released to other proprietors. To achieve reconciliation for the head-to-head gaming application and yet avoid this problem, it is desirable for the reconciling data centre to receive information that relates only to the head-to-head application. This can be achieved by tagging the messages appropriately. Thus, information relating to game play on the other games can be prevented from being diverted to the reconciliation data centre.

The MOM may be IBM's MQ series middleware product. An advantage of this product is that it offers guaranteed single delivery of messages. This can prevent duplication of message deliveries from causing errors in the reconciliation calculation. The MQ product is also able to permit the subscribers to disconnect from the system for a period of time. During this time any messages for the subscriber will be stored in the MOM, to be delivered when the subscriber reconnects later.

Thus, in a further aspect of the invention, the network may include message oriented middleware connected between a data centre and the remote user terminals, wherein each user terminals is arranged to publish to the middleware messages related to the head-to-head game play that has taken place on that terminal, the message includes an identifying tag, information identifying the location of the terminal, and information relating to the gamble stake and interlinked terminal; and wherein the data centre is arranged to subscribe to messages received in the middleware. The data centre may subscribe only to messages whose identifying tags indicate that they contain financial information about head-to-head game play.

1-15. (canceled)

16. An electronic gaming network for allowing two or more remote users to engage in game play, the network comprising:
a server and two or more remote user terminals which are communicable with one another via the server, each terminal including a credit receiving means arranged to receive monetary input, and each terminal being arranged to allocate credit to the user of that terminal based on the value of their monetary input;
a display for showing game play;
a user operable game control means for controlling game play; and
a payment awarding means arranged to deliver a physical payment to a user;
wherein the network is arranged:
to receive play requests in the server from the two or more user terminals,
to receive gamble stakes in the server from the two or more user terminals, each gamble stake comprising all or part of the credit allocated to a user on a respective user terminal,
to interlink two or more user terminals to enable the users of the interlinked user terminals to engage in game play with one another based on the received play request,
to calculate a win value on the basis of the received gamble stakes, and
to cause a winnings amount to be delivered after game play concludes by the payment awarding means of the terminal of the user who wins the game play, the winnings amount being based on the calculated win value.

17. The network of claim 16, wherein the remote user terminals are located in separate venues spread over a geographical area.

18. The network of claim 17, wherein a plurality of remote user terminals are provided in a single venue and are communicable with each other over a local area network (LAN).

19. The network of claim 17, wherein the remote user terminals are communicable over a wide area network (WAN).

20. The network of claim 16, wherein the display and user operable game control means on one or more of the terminals are combined in a touch screen.

21. The network of claim 16, wherein each play request includes a first identifier for the terminal sending the request and a second identifier for the game that the user wishes to play.

22. The network of claim 21, wherein the network is arranged to interlink two or more user terminals which have sent play requests with a second identifier for the same game.

23. The network of claim 21, wherein, on receipt of a play request, the server is arranged to communicate a lobby screen to the requesting terminal, the lobby screen depicting links to other terminals from which play requests with the same second identifier have been received, any one or more of the links being selectable at the requesting terminal.

24. The network of claim 16, wherein each play request has a fixed gamble slake associated therewith.

25. The network of claims 16-22, wherein the gamble stake is selectable on each user terminal.

26. The network of claim 25, wherein the server is arranged to interlink two or more user terminals before the gamble stakes are received in the server to permit a gamble stake negotiation between the interlinked user terminals, whereby each interlinked terminal is arranged to:
permit a user to select a proposed gamble stake,
send the proposed gamble stake to each of the other interlinked terminals,
receive and display an offered gamble stake from each of the other interlinked terminals,
permit a user to accept or reject the offered gamble stake, and
receive an indication from each of the other interlinked terminals whether the proposed gamble stake is accepted or rejected; and
wherein the network is arranged to permit game play to commence between two or more of the interlinked terminals each of which has indicated acceptance of the proposed gamble stake of the others.

27. The network of claim 26, wherein, for each game, the interlinked terminals are arranged to send to the server terminal identifying information and game outcome information.

28. The network of claim 27, wherein the terminal identifying information includes the identity or location of the interlinked terminal involved in the game.

29. A computer terminal adapted to receive monetary input and to deliver physical payment comprising:
a terminal being communicable with remote terminals and being arranged to:
enable a user to engage in game play with another user on a remote terminal;
facilitate betting on the outcome of that game play with the other user; and
deliver a physical winnings payment based on the outcome of that game play.

30. The computer terminal of claim 29, wherein the terminal is arranged to:
permit a user to select a proposed gamble stake;
send the proposed gamble stake to a remote terminal;
receive and display an offered gamble stake from the remote terminal;
permit a user to accept or reject the offered gamble stake;
receive an indication from the remote terminal whether the proposed gamble stake is accepted or rejected; and
permit game play with the remote terminal to commence after the proposed gamble stake is accepted.
